(19) United States
(12) Patent Application Publication
(10) Pub. No.: US 2015/0287065 A1
(43) Pub. Date: Oct. 8, 2015

(54) LINKING PROMOTIONAL TERMS

(71) Applicant: ESI - EXCHANGE SOLUTIONS, INC., LINCOLN, MA (US)

(72) Inventors: Paul Peios, Woodbridge (CA); Lawrence Richardson, Caledon East (CA)

(21) Appl. No.: 14/244,509

(22) Filed: Apr. 3, 2014

(51) Int. Cl. G06Q 30/02; G06Q 50/06

(52) U.S. Cl. CPC G06Q 30/0222; G06Q 50/06

(57) ABSTRACT

Among other things, a computer-implemented method includes: identifying terms of a promotion associated with a vehicle model; determining a vehicle identification number associated with the identified terms of the promotion, the determination based on: 1) a relationship between the vehicle model and the vehicle identification number, and 2) a transaction that identifies the vehicle identification number as associated with a purchase tool; and in response to a request to activate the purchase tool, linking the purchase tool to the terms of the promotion.

### BACKGROUND

This description relates to facilitating promotional programs associated with commercial transactions.

A commercial transaction may involve an exchange of money for goods and services. In some examples, a commercial transaction can include an enticement to purchase in the form of a promotional offer.

### SUMMARY

The techniques that we describe here may encompass one or more of the following (and other) aspects, features, and implementations, and combinations of them.

In one aspect, in general, a computer-implemented method includes: identifying terms of a promotion, the terms being associated with a vehicle model; determining a vehicle identification number associated with the identified terms of the promotion, the determination based on: 1) a relationship between the vehicle model and the vehicle identification number, and 2) a transaction that identifies the vehicle identification number as associated with a purchase tool, and in response to a request to activate the purchase tool, linking the purchase tool to the terms of the promotion.

Implementations of this aspect may include one or more of the following features. The promotional terms include a discount of fuel. The promotional terms include a discount of fuel up to a maximum number of units. The promotional terms depend on the vehicle model number. Identifying terms of a promotion, the terms being associated with a vehicle model includes determining a relationship between the vehicle identification number and a vehicle dealer. The terms of a promotion are limited to the vehicle identification number associated with the vehicle dealer. The terms of a promotion vary according to the vehicle dealer. The transaction further identifies at least one of the following: vehicle options, accessories, extended warranty, financing company, prepaid services, and rust protection. The terms of a promotion vary according to at least one of the following: vehicle options, accessories, extended warranty, financing company, prepaid services, and rust protection. The vehicle dealer transmits data representing a transaction including a vehicle identification number associated with a purchase tool. The purchase tool is a gift card.

In another aspect, in general, a method includes identifying terms of a promotion, the terms being associated with a vehicle identification number; determining the vehicle identification number associated with the identified terms of the promotion, the determination based on a transaction that identifies the vehicle identification number as associated with a purchase tool; and in response to a request to activate the purchase tool, linking the purchase tool to the terms of the promotion.

Implementations of this aspect may include one or more of the following features. The promotional terms include a discount of fuel. The promotional terms include a discount of fuel up to a maximum number of units. The promotional terms include a discount for a set period of time. The promotional terms depend on the vehicle identification number. Identifying terms of a promotion, the terms being associated with a vehicle model includes determining a relationship between the vehicle identification number and a vehicle dealer. The promotional terms are limited to the vehicle identification number associated with the vehicle dealer. The vehicle dealer transmits data representing a transaction including a vehicle identification number associated with a purchase tool. The purchase tool is a gift card.

In yet another aspect, in general, an electronic system includes one or more processing devices; one or more machine-readable hardware storage devices storing instructions that are executable by the one or more processing devices to perform operations comprising: identifying terms of a promotion, the terms being associated with a vehicle model; determining a vehicle identification number associated with the identified terms of the promotion, the determination based on: 1) a relationship between the vehicle model and the vehicle identification number, and 2) a transaction that identifies the vehicle identification number as associated with a purchase tool; and in response to a request to activate the purchase tool, linking the purchase tool to the terms of the promotion.

In another aspect, in general, an electronic system includes one or more processing devices; one or more machine-readable hardware storage devices storing instructions that are executable by the one or more processing devices to perform operations comprising: identifying terms of a promotion, the terms being associated with a vehicle identification number; determining the vehicle identification number associated with the identified terms of the promotion, the determination based on: a transaction that identifies the vehicle identification number as associated with a purchase tool; and in response to a request to activate the purchase tool, linking the purchase tool to the terms of the promotion.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 shows a block diagram.

FIG. 2 shows a flowchart.

FIGS. 3a-3b show an example of graphical user interface of a promotion administration facility portal.

FIG. 4 shows a computer system.

### DETAILED DESCRIPTION

A system can link promotional terms with a purchased vehicle based in part on the vehicle's vehicle identification number (“VIN”). A commercial entity (e.g., a vehicle dealership or vehicle manufacturer) sometimes offers its customers a promotional offer in combination with a purchase or sale. The commercial entity can offer a promotion having a multiple promotional terms. These terms may vary based on the vehicle model or on the point of sale (e.g., the particular vehicle dealership). For example, one set of promotional terms may apply to one vehicle model, while another set of promotional terms may apply to another vehicle model.

As a real-world example, a consumer buys a vehicle from an auto dealership and the auto dealership enters a purchase tool number and a VIN into a system (e.g., web interface available on the Internet) operated by a promotional administration facility. The purchase tool is then queued for activation and waiting on activation instructions. Further, the card number and VIN are linked together, e.g., in a database. Generally, when we say that two concepts are linked, we mean that data that associates the two concepts with each other is generated and stored. While, the examples described are generally with respect to a promotional card relating to the purchase of gasoline, the purchase tool 128 could be a gift card (e.g., a total value of currency that runs down as you use the card), a discount (e.g., a quantity of product that you can purchase at a discount), or points (e.g., a quantity that could accumulate to give some benefit).

The promotion administration facility determines the set of promotional terms for which the vehicle purchase transaction qualifies based on the VIN. The VIN can be used to determine a model of the vehicle, and in turn, the model of the vehicle can be used to determine the promotional terms for which the consumer is eligible. When a set of eligible promotional terms is found, the promotional administration facility loads the matching purchase tool with a value according to the terms of the promotion specified by the vehicle manufacturer. For example, the promotion may have terms specified in quantitative limits, such as a number of units (e.g., gallons and/or liters) of fuel that receive a discounted price. Any missing card numbers can be kept in the queue for activation until further instruction is received.

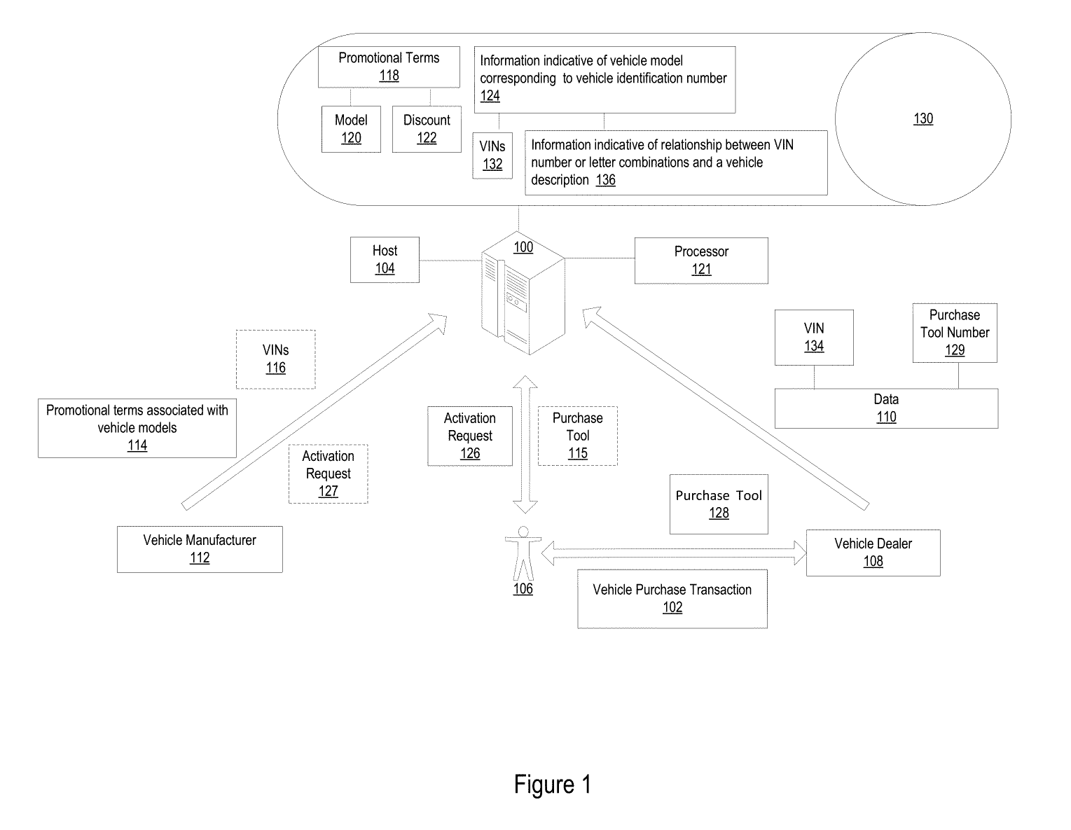

FIG. 1 shows an example of a promotion administration facility 100 that manages the promotional terms associated with the promotions and associates the correct promotional terms with vehicle purchase transaction 102. The electronic promotion administration facility 100 may be associated with a host 104. The host 104 manages the promotion administration facility 100, for example, and determines which vehicle purchase transactions 102 are supported by the promotion administration facility 100. In some examples, the host 104 can be an entity such as a business that operates the promotion administration facility 100. In some implementations, the promotion administration facility 100 may have at transaction processor 121 that processes data 110, 116, 114 relevant to vehicle purchase transaction 102 and stores the data in a database 130. For example, the transaction processor 121 can receive data 110 from a vehicle dealer 108 and take action in response to the data 110. For example, the data can include a purchase tool number 129 and a VIN 134. The transaction processor 121 update data stored in the database 130 and respond to vehicle dealer 108 to link a purchase tool 128 with promotional terms. Data stored in the database 130 can include the promotional terms 118 set by the vehicle manufacturer including identifiers of vehicle models 120 associated with each set of promotional terms and the discounts 122 available with each set of promotional terms. The processor 121 can also store information indicative of vehicle models corresponding to VINs 124 in the database 130.

The vehicle manufacturer 112 transmits promotional terms 114 to the promotion administration facility 100. In some examples, the vehicle manufacturer 112 transmits VINs 116 of vehicles authorized to be associated with promotional terms 114 to the promotion administration facility 100. The VINs 116 need not be transmitted in association with data indicating which promotional terms 114 are associated with which VINs; instead, the association of VINs 116 and promotional terms 114 can be determined by the promotion administration facility 100.

In some examples, the VINs 116 provided by the vehicle manufacturer 112 are sent frequently to the promotion administration facility 100 while the promotion is being offered to facilitate linking the promotional terms 114 and VINs 116 provided by the vehicle manufacturer 112 to the data 110 provided by the vehicle dealer 108. In other examples, the promotional terms associated with vehicle models 114 are sent to the electronic administration facility and stored in database 130 in advance of an eligible vehicle purchase transaction 102, e.g., before the promotion begins. In some examples, the transaction processor 121 can determine if a purchase tool distribution is authorized based on the contents of the database 130. The transaction processor 121 may include one or more computer systems, e.g., a server or multiple servers in communication with a network.

In this example, a person 106 engages in a vehicle purchase transaction 102 and purchases a vehicle from a vehicle dealer 108. In some cases, the transaction (e.g., the vehicle purchase transaction 102) with the commercial entity (e.g., the vehicle dealer) has a relationship to the promotional terms. For example, a vehicle uses gasoline so that, from a marketing point of view, there is a connection between the purchase of a vehicle and a discount on the price of gasoline (which will be used by the vehicle) in the mind of the consumer.

The purchase tool 128 is used by the person 106 in connection with purchasing a commodity based on the set of promotions terms. In some examples, the purchase tool 128 can be a card that is specially configured so that it enables the person 106 to purchase the commodity at a previously negotiated price or protected price (as discussed below) through the medium of the promotion administration facility 100. Some examples of purchase tools are credit cards, debit cards, stored value cards, gift cards, and prepaid cards. A purchase tool may have a magnetic strip, bar code, or electronic tag that identifies the card. In some examples, the purchase tool 128 could be a mobile application, e.g., an application that runs on a mobile device such as a smartphone and communicates with a commercial. In some examples, the purchase tool 128 can be a short-range wireless device (e.g., RFID device) that communicates with a commercial entity to facilitate a transaction. In another example, the purchase tool 128 could be a gift card (e.g., a total value of currency that runs down as you use the card), a discount (e.g., a quantity of product that you can purchase at a discount), or points (e.g., a quantity that could accumulate to give some benefit). The purchase tool 128 can also take other forms or combinations of them. The configuration of the purchase tool or the issuance of the purchase tool can be managed by the host 104 of the promotion administration facility 100 on behalf of a commercial entity. In this way, a commercial entity need not manage any infrastructure to support the use of the purchase tool 128. In a transactional arrangement illustrated by FIG. 1, the vehicle purchase transaction 102 qualifies for a certain promotion. A vehicle manufacturer sends data representing promotional terms associated with specific vehicle models 114. The promotion administration facility stores information indicative of the relationship between a VIN, e.g., a number and/or letter combination, and a vehicle description. For example, a VIN has 17 “positions” that include a number or a letter in each position. In an exemplary code for determining a vehicle description, position 1 indicates country of origin information, position 2 indicates the manufacturer information, position 3 indicates the vehicle type or manufacturer division information, positions 4-8 indicate vehicle description information, position 9 indicates a check digit information, positions 10-17 indicate vehicle identification information. For example, vehicle description information can include positions indicating the model, body, style, engine type, transmission, and so forth, and the vehicle identification information can indicate model year information, assembly plant information, production or serial number information, and so forth. Generally, the promotion administration facility 110 processor 121 parses the vehicle description information for model information. In other examples, processor 121 may analyze a combination of information conveyed by the decoded VIN to link the correct promotional terms with the vehicle.

As part of a vehicle purchase transaction 102, the vehicle dealer 108 sends to the promotion administration facility data 110 representing the purchase tool 128 and the VIN 134. The promotion administration facility 100 then links the purchasing tool 128 to the correct promotional terms (e.g., stores an association between the purchase tool number and promotional terms) by comparing the data provided by the vehicle manufacturer with the data provided by the vehicle dealer. For example, the promotion administration facility examines the VIN provided by the vehicle dealership to determine a model number indicated by the VIN. After determining the model number, the promotion administration facility 100 determines the correct promotional terms to link with the purchase tool by analyzing the promotional terms associated with vehicle model data provided by the vehicle manufacturer. Once the promotion administration facility 100 has identified promotional terms, the promotion administration facility 100 links the purchase tool number 129 with the eligible promotional terms. In this way, all promotion administration is centralized at the promotion administration facility and removes any responsibility from the vehicle dealerships to determine the correct promotional terms offered by the vehicle manufacturer. Instead, the dealer only needs to enter the purchase tool number and VIN. Further, purchase tools can be sent to dealers and used for any make or model of car. In certain examples, the purchase tool is not activated until the user 106 submits a separate activation request 126.

As another real-world example, promotional terms are associated with vehicle models. For example, vehicle models are broken down into three tiers: vehicle models eligible for promotional terms including up to 1,000 L, 1,500 L, or 2,000 L of gasoline. During the purchase transaction, the vehicle dealership enters a purchase tool number and VIN into the promotion administration facility. The card is queued for activation and awaits further instructions. This action links the purchase tool number and VIN together. While the promotion administration facility 100 can determine the vehicle model number based on the VIN provided by the vehicle dealer 108, the vehicle manufacturer may also optionally provide a feed (e.g., daily) of all approved VIN's and their associated model numbers. The vehicle manufacturer may also provide the promotional terms, e.g., tier, associated with each model number. The promotion administration facility the compares the data from the manufacturer, e.g., the VIN-to-model relationship, and/or the model number indicated by the VIN with the promotional terms associated with the model against the data from the vehicle dealership (Card+VIN) using the VIN as the common data on each side. When a match is found, the promotion administration facility loads the matching card with the appropriate number of units (e.g., gallons and/or liters) based on promotional terms provided by the vehicle manufacturer and associated with the model number. Any missing card numbers are kept in the queue awaiting further instructions. If VIN's are found in the data from the dealership, but not in the data from the manufacturer, the discrepancy is reported to the manufacturer.

In another example, the vehicle purchase transaction 102 qualifies for a certain promotion. A vehicle manufacturer sends data representing specific VINs 116 authorized to be associated with promotional terms to the promotion administration facility 100. The data 116 is shown in FIG. 1 using a dotted line to indicate that this data is optional. For example, if the vehicle manufacturer 112 does not provide VINs 116, the promotion administration facility 100 analyzes the VIN 134 (as described above) provided by the vehicle dealer 108 to determine the vehicle model. In this way, it is optional for the vehicle manufacturer 112 to provide the VINs 116 authorized for a promotion. As part of a vehicle purchase transaction 102, the vehicle dealer 108 sends to the promotion administration facility data 110 representing the purchase tool number 129 and the VIN 134. The promotion administration facility 100 then links the purchase tool number to the correct promotional terms by comparing the data provided by the vehicle manufacturer with the data provided by the vehicle dealer, and then storing data representing the link. Essentially, the promotion administration facility compares the VIN provided by the vehicle dealership with the VIN data and/promotional terms data provided by the vehicle manufacturer. This centralizes all promotion administration at the promotion administration facility and removes any responsibility from the vehicle dealerships to determine the correct promotional terms offered by the vehicle manufacturer; instead, the dealer only needs to enter the purchase tool number and VIN. Further, purchase tools can be sent to dealers and used for any make or model of car. In some examples, purchase tools may be designated for use with a specific vehicle manufacturer (e.g., printed with a logo of a specific vehicle manufacturer), and any of those purchase tools could be linked with any of several different promotional terms depending on a model of vehicle linked to the purchase tool. In this technique, the vehicle manufacturer 112 can limit promotional discounts to certain dealerships. For example, the vehicle manufacturer is enabled to associate only VINs at certain dealerships with promotional terms. In this example, the data representing specific VINs 116 need not include promotional terms for each of the VINs. Instead, the promotion administration facility 100 can use the data representing promotional terms associated with specific vehicle models 114 to determine what promotional terms should be associated with the VINs 116 (e.g., assigned to respective purchase tools associated with the respective VINs).

In other examples, the vehicle manufacturer 112 sends to the promotion administration facility 100 data representing an activation request 127. In this example, the activation request can include the promotional terms to be associated with a purchase tool and the contact information for a user 106. Upon receipt of the activation request 127, the promotion administration facility can associate a purchase tool 115 with the promotional terms included in the activation request 127. The promotion administration facility can then send the linked purchase tool 115 directly to the user 106.

In certain examples, the purchase tool is authorized with promotional terms including a set monetary value. For example, a promotion may offer a set benefit, e.g., a set dollar amount representing an aggregate discount off the price of fuel. In this example, the terms of a promotion may offer a gift value of $500 for a Ford Escape, $1,000 for a Ford Edge, and so forth. Thus, if a consumer purchases a Ford Escape, the consumer receives a discount off the price of fuel, up to a total value of $500.

In other examples, the purchase tool is authorized with promotional terms including a certain number of units (e.g., gallons and/or liters) of gasoline, which are prepaid and can be purchased without charge to the purchase tool holder. For example, a promotion may offer a set benefit, e.g., a set quantity of gasoline representing the total gasoline accessible via the purchase tool, e.g., up to 1,000 L, 1,500 L, 2,000 L, and so forth of gasoline. In yet another example, a promotion may offer a set benefit representing the total discount for a set quantity of gasoline accessible via the purchase tool, e.g., 30 cents off per liter and a number of eligible units (e.g., gallons and/or liters), 30 cents off per liter for 1000 L. The terms of the promotion may vary according to the vehicle model. For example, for an Escape model, the promotion may offer 40 cents off per liter for 1,500 L while, for an Edge model the promotion may offer 20 cents off per lite for 1,000 L, and so forth. In other examples, the promotional terms may include a price protection as described in U.S. application Ser. No. 13/852,692, which is hereby incorporated by reference. In this example, any fluctuations in the cost of the goods authorized by the promotional terms can be price protected. This protection would prevent unexpected economic harm to the parties in interest.

In some implementations, the purchase tool 128 can be used with a single commercial entity. For example, a single gasoline company may accept transactions involving the purchase tool 128. This arrangement is sometimes referred to as a “closed loop.” For example, the purchase tool could be a purchase tool issued by a gasoline company and accepted only by service stations associated with the gasoline company, e.g., branded with the gasoline company name or a franchisee of the gasoline company.

In some implementations, the purchase tool 128 can be used with multiple commercial. For example, multiple gasoline companies may accept transactions involving the purchase tool. This arrangement is sometimes referred to as an “open loop.” In some cases, the purchase tool could be a credit card, such as a MasterCard, that is accepted by virtually any brand of gasoline company. An open loop is sometimes facilitated by a Restricted Authorization Network (RAN). A restricted authorization network is, for example, an agreement among commercial entities to accept the purchase tool 128.

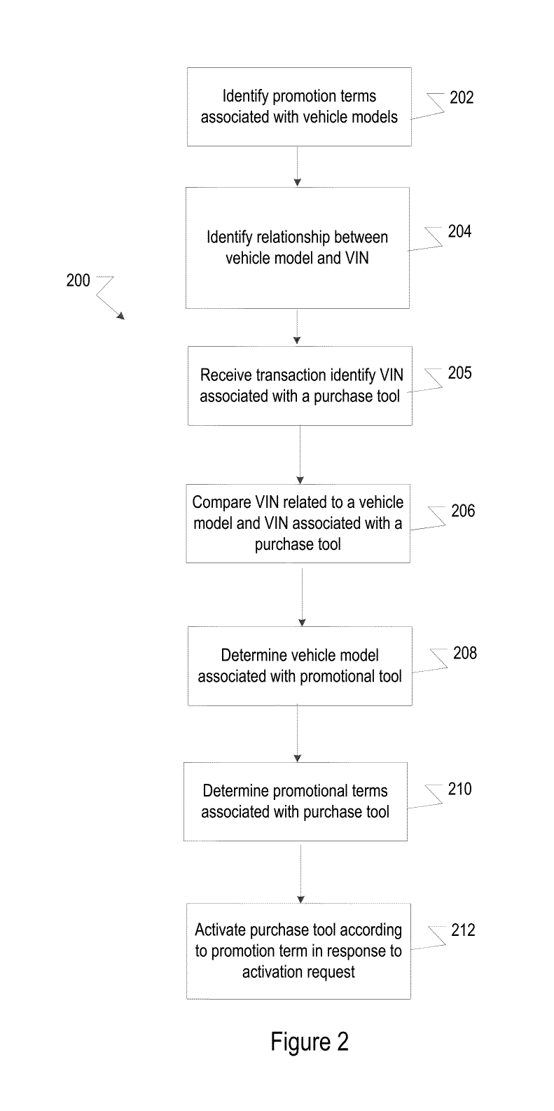

FIG. 2 shows an example process 200 for linking the purchase tool to the terms of the promotion. The process 200 is described with respect to the purchase tool 128 as shown in FIG. 1. For example, the process 200 can be carried out by the promotion administration facility 100 at the time of the transaction.

Data describing a relationship between a promotion terms and vehicle models is identified (202). This data may include, but not limited to a list of vehicle models corresponding to: a total monetary value; a number of redeemable units (e.g., gallons and/or liters) of gasoline; a number of cents off of a gasoline price and a total monetary value; and/or a total number of cents off of a gasoline a and a ceiling redemption value.

Data describing a relationship between a vehicle model and a VIN is identified (204). Generally, a VIN represents a specific car thus the VIN also indicates the vehicle model number. This data may include vehicle models manufactured by one or more vehicle manufacturers and VINs associated with each model. Alternatively, this data may represent the correspondence between the positions, e.g., the order of the number and letters that compose a VIN, and description of the vehicle model as described above.

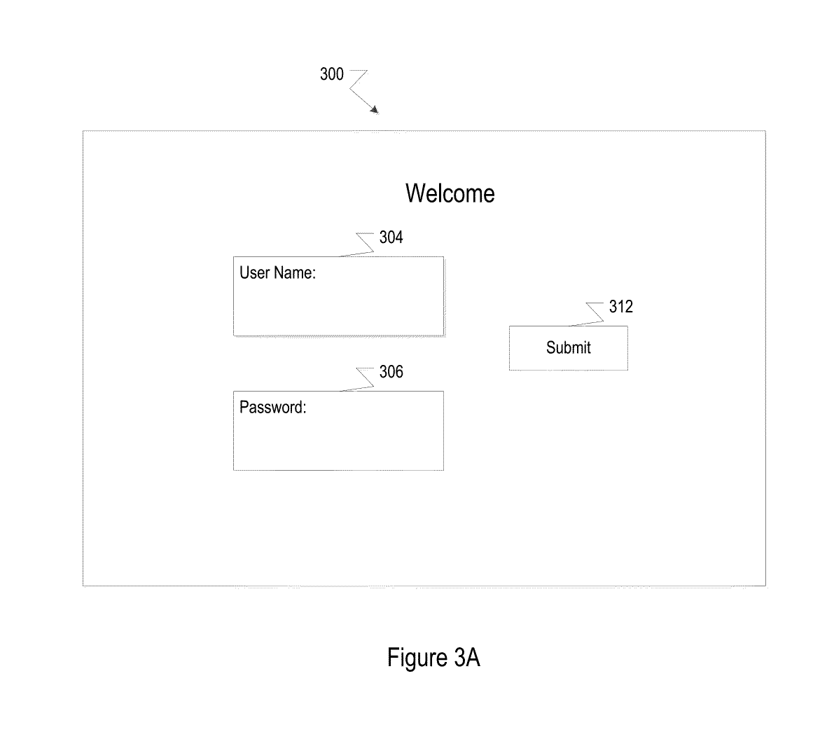

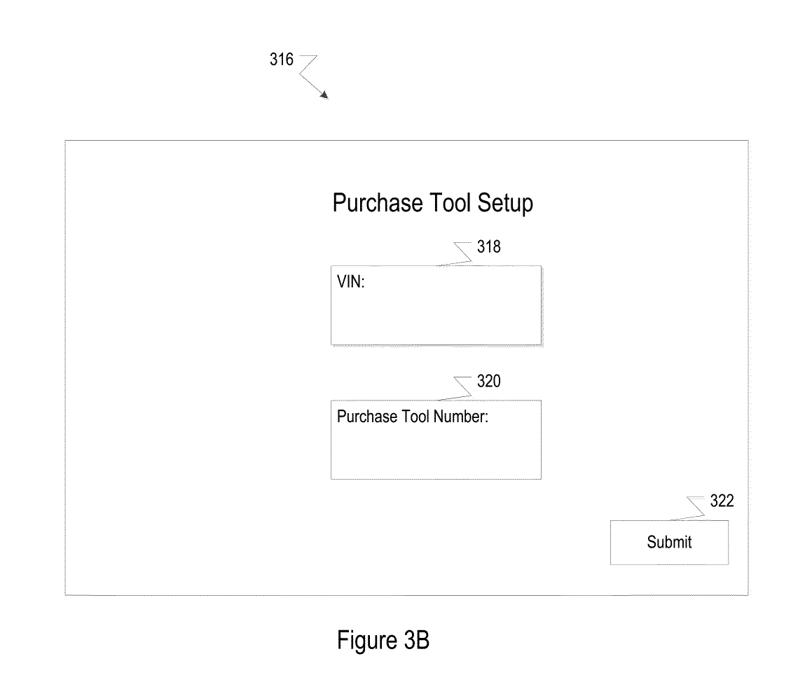

Data describing a transaction is received (205). The data may include, but not be limited to an identification of the vehicle dealer, a model number, a VIN, a purchase price, a date, a dealership identification number, a purchase tool number, vehicle options (e.g., Bluetooth, heated seats, and so forth), accessories (e.g., rubber floor mats), extended warranty, financing company, prepaid services, rust protection, and so forth. The available promotional terms can be linked to a vehicle based on at least one or a combination of this data. For example, a particular model can be eligible for a certain set of promotional terms. In another example, a model can be eligible for a set of promotional terms, but a model having certain vehicle options (e.g., heated seats) can be eligible for a second set of promotional terms. In this way, the promotional terms 118 associated with a particular purchase tool 128 can be determined based on factors in addition to a VIN 132. In some examples, that data includes at least the VIN of the purchased vehicle and the purchase tool number. For example, this data could be provided using the user interface 300 shown in FIGS. 3a and 3b.

Data relating a VIN to a vehicle model is compared with a VIN associated with a purchase tool (206) using the VIN as the common data on each side. In some examples, data relating a VIN to a vehicle model is compared with a VIN associated with a purchase tool (206) is compared at an earlier step, e.g., at a point before a match is found. When a match is found, based on this comparison, the vehicle model associated with the purchase tool is determined (208). For example, VIN:Model information (either provided by the vehicle manufacturer 110 or decoded by the promotion administration facility 100) is compared with VIN:Purchase tool information. By substituting the model information from the former into the latter, the model:purchase tool information is determined. Based on the vehicle model associated with the purchase tool, the promotional terms associated with the purchase tool, e.g., the terms linked with the vehicle model by the vehicle manufacturer, are determined (210). In some examples, other information is similarly linked to the purchase tool to determine appropriate promotional terms, e.g., vehicle option information, accessory information, extended warranty information, financing company information, prepaid services information, rust protection information, and so forth. In other examples, promotional terms may be broken down based on the car model or a category to which a car model belongs. For example, the promotional terms can be based on tiers. The vehicle manufacturer can choose to place all SUVs in tier 1, all sports cars in tier 2, and all smart cars in tier 3. The set of promotion terms may vary based on these tiers and/or categories. In response to a request to activate the purchase tool, either by the vehicle dealer 108, user 102, or vehicle manufacturer 112, the purchase tool is linked to the promotional terms (212). For example, a purchase tool can be linked to the promotional terms by storing the purchase tool number associated with the promotional terms. In this way, when user 106 attempts to redeem purchase tool 128, the transaction is validated based on the stored promotional terms. Alternatively, the promotional terms associated with the purchase tool can be transferred to a third party handling the validation procedures. In this way, a purchase tool is linked with promotional terms, but the vehicle dealer is only required to provide the purchase tool number and the VIN.

Referring now to FIGS. 3a-3b, a screen image of a graphical user interface 300 is shown that can be used by a vehicle dealer 108 (FIG. 1) to enter a portal to facilitate submission requests to link promotional terms with purchase tools. The graphical user interface includes user name login field 304, a password field 306, and a selectable “Submit” field to submit the login request. In this example, a vehicle dealer logs into the system with their unique registered user name and password, and is brought to a submission request portal 316 including a VIN field 318, a purchase tool field 320, and a selectable “Submit” field 322 to submit the authorization request. In this example, a vehicle dealer submits the VIN 134 and purchase tool number 129 associated with the vehicle purchase transaction 102. After the completion of these fields, the vehicle dealer 108 can select submit to complete the vehicle dealer's contribution to the linking and/or associating process. In other examples, the submission request portal includes additional fields if additional data is requested (e.g., vehicle option information, accessory information, extended warranty information, financing company information, prepaid services information, rust protection information and so forth).

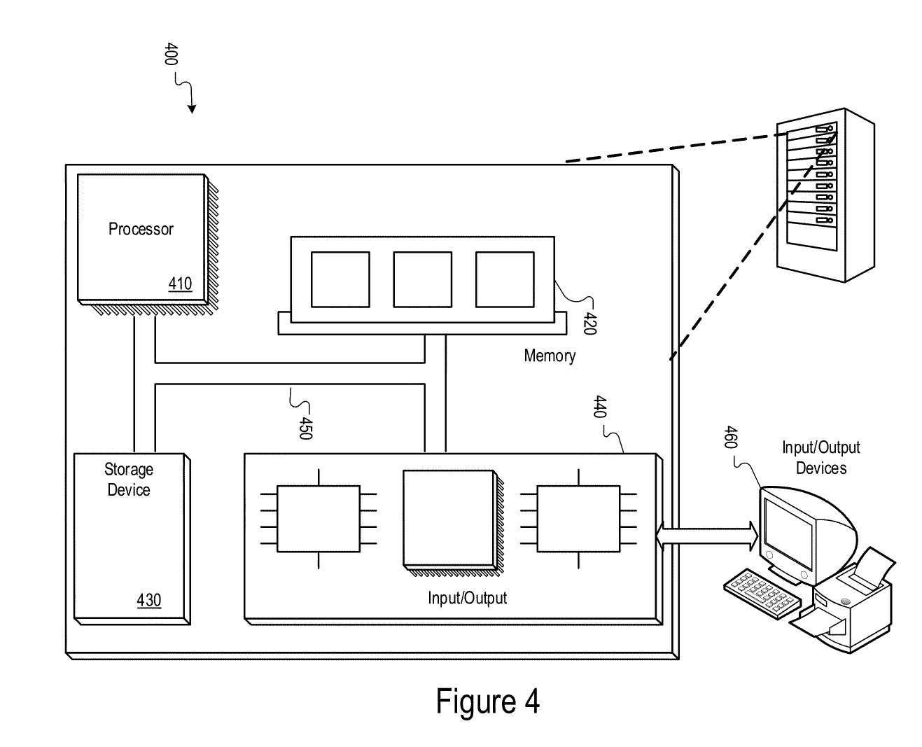

FIG. 4 is a block diagram of an example computer system 400. For example, referring to FIG. 1, the promotion administration facility 100 or a server forming a portion of the promotion administration facility 100 could be an example of the system 400 described here, as could a computer system used by any of users who access resources of the promotion administration facility 100 (e.g., a user associated with the host 104 who configures operations of the promotion administration facility 100). The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In some implementations, the processor 410 is a multi-threaded processor. In some implementations, the processor 410 is a quantum computer. The processor 410 is capable of processing instructions stored in the memory 420 or on the storage device 430.

The memory 420 stores information within the system 400. In some implementations, the memory 420 is a computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a solid-date drive, a flash drive, magnetic tape, or some other large capacity storage device. The input/output device 440 provides input/output operations for the system 400. In some implementations, the input/output device 440 can include one or more of a network interface devices, e.g., an Ethernet card, a serial communication device, e.g., an RS-232 port, and/or a wireless interface device, e.g., an 802.3 card, a 3G wireless modem, a 4G wireless modem, or a carrier pigeon interface. In some implementations, the input/output device can include driver devices configured to receive input data and send output data to other input/output devices, e.g., keyboard, printer, and display devices 460. In some implementations, mobile computing devices, mobile communication devices, and other devices can be used. A server (e.g., a server forming a portion of the promotion administration facility 100 shown in FIG. 1) can be realized by instructions that upon execution cause one or more processing devices to carry out processes relevant to the functions described above. Such instructions can comprise, for example, interpreted instructions such as script instructions, or executable code, or other instructions stored in a computer readable medium. A server can be distributively implemented over a network, such as a server farm, or a set of widely distributed servers or can be implemented in a single virtual device that includes multiple distributed devices that operate in coordination with one another. For example, one of the devices can control the other devices, the devices may operate under a set of coordinated rules or protocols, or the devices may be coordinated in another fashion. The coordinated operation of the multiple distributed devices presents the appearance of operating as a single device.

A number of examples of the invention have been described. Nevertheless, it will be understood that various modifications may be made without departing from the spirit and scope of the invention.

What is claimed is:

1. A computer-implemented method comprising:
identifying terms of a promotion, the terms being associated with a vehicle model;
determining a vehicle identification number associated with the identified terms of the promotion, the determination based on:
1) a relationship between the vehicle model and the vehicle identification number, and
2) a transaction that identifies the vehicle identification number as associated with a purchase tool; and
in response to a request to activate the purchase tool, linking the purchase tool to the terms of the promotion.

2. The method of claim 1 in which the terms includes a discount of fuel.

3. The method of claim 1 in which the terms include a discount of fuel up to a maximum number of units.

4. The method of claim 1 in which the terms depends on the vehicle model number.

5. The method of claim 1 comprising determining a relationship between the vehicle identification number and a vehicle dealer.

6. The method of claim 5 wherein the terms are limited to the vehicle identification number associated with the vehicle dealer.

7. The method of claim 5 in which the terms vary according to the vehicle dealer.

8. The method of claim of claim 1 in which the transaction further identifies at least one of the following: vehicle options, accessories, extended warranty, financing company, prepaid services, and rust protection.

9. The method of claim 8 in which the terms vary according to at least one of the following: vehicle options, accessories, extended warranty, financing company, prepaid services, and rust protection.

10. The method of claim 1 in which a vehicle dealer transmits data representing a transaction including a vehicle identification number associated with the purchase tool.

11. The method of claim 1 in which the purchase tool comprises a gift card.

12. A method comprising:
identifying terms of a promotion, the terms being associated with a vehicle identification number;
determining the vehicle identification number associated with the identified terms of the promotion, the determination based on:
a transaction that identifies the vehicle identification number as associated with a purchase tool; and
in response to a request to activate the purchase tool, linking the purchase tool to the terms of the promotion.

13. The method of claim 12 in which the terms include a discount of fuel.

14. The method of claim 12 in which the terms include a discount of fuel up to a maximum number of units.

15. The method of claim 12 in which the terms include a discount for a set period of time.

16. The method of claim 12 in which the terms depend on the vehicle identification number.

17. The method of claim 12 comprising determining a relationship between the vehicle identification number and a vehicle dealer.

18. The method of claim 17 wherein the terms are limited to the vehicle identification number associated with the vehicle dealer

19. The method of claim 12 in which a vehicle dealer transmits data representing a transaction including a vehicle identification number associated with the purchase tool.

20. The method of claim 12 in which the purchase tool comprises a gift card.

21. An electronic system comprising:
one or more processing devices;
one or more machine-readable hardware storage devices storing instructions that are executable by the one or more processing devices to perform operations comprising:
identifying terms of a promotion, the terms being associated with a vehicle model;
determining a vehicle identification number associated with the identified terms of the promotion, the determination based on:
1) a relationship between the vehicle model and the vehicle identification number, and
2) a transaction that identifies the vehicle identification number as associated with a purchase tool; and
in response to a request to activate the purchase tool, linking the purchase tool to the terms of the promotion.

22. An electronic system comprising:
one or more processing devices;
one or more machine-readable hardware storage devices storing instructions that are executable by the one or more processing devices to perform operations comprising:
identifying terms of a promotion, the terms being associated with a vehicle identification number;
determining the vehicle identification number associated with the identified terms of the promotion, the determination based on:
a transaction that identifies the vehicle identification number as associated with a purchase tool; and
in response to a request to activate the purchase tool, linking the purchase tool to the terms of the promotion.
